(19) United States
(12) Patent Application Publication
(10) Pub. No.: US 2016/0042720 A1
(43) Pub. Date: Feb. 11, 2016

(54) PANEL SELF-REFRESH SYSTEM AND METHOD

(71) Applicant: HIMAX TECHNOLOGIES LIMITED, Tainan City (TW)

(72) Inventor: Chi-Cheng Chiang, Tainan City (TW)

(21) Appl. No.: 14/455,888

(22) Filed: Aug. 9, 2014

(51) Int. Cl. G09G 5/18; G06T 1/60; G09G 3/36

(52) U.S. Cl. CPC G09G 5/18; G09G 3/3674; G06T 1/60

(57) ABSTRACT

A panel self-refresh system includes a timing controller configured to receive a command or an incoming frame from a processor, the incoming frame being forwarded to a display panel in a normal state. The system also includes a frame buffer configured to store the incoming frame in a cache state or an update state, contents of the frame buffer being read as an outgoing frame to the display panel in a self-refresh state. The timing controller generates a reset signal to a gate driver when the processor sends an update command for entering the update state or sends an exit command for entering a resynchronization state, scan signals outputted from a gate driver being de-asserted and staying in a vertical blanking interval until a next incoming frame is received from the processor.

### BACKGROUND OF THE INVENTION

1. FIELD OF THE INVENTION

The present invention generally relates to a panel self-refresh system and method, and more particularly to reset synchronization for the panel self-refresh system and method.

2. DESCRIPTION OF RELATED ART

A display panel such as a liquid crystal display (LCD) is an output device for presentation of information in visual form. Take the LCD as an example, a timing controller receives frames each composed of coded still image generated from a graphics processing unit (GPU). The timing controller forwards the received frames to the LCD panel, and accordingly controls the LCD panel such that the contents of the frames may be properly displayed on the LCD panel.

It is not uncommon at times that there are no changes between the generated frames. In this situation, conventional display systems continuously generate and forward the frames, therefore wasting power consumption and transmission bandwidth.

In order to save the power consumption and bandwidth, a scheme called self-refresh has been proposed to stop generating the frames with the same contents and reuse one of the frames until changes between the frames have been detected. Upon detecting the changes, the display system resumes the operation. However, as the graphics processing unit and the timing controller may usually operate at different timings, extra actions need be performed in order to synchronize the graphics processing unit and the timing controller. Unfortunately, in the conventional display systems, a delay ordinarily ensues when synchronizing the graphics processing unit and the timing controller.

For the reason that conventional display systems could not effectively perform self-refresh, particularly when the operation is being resumed, a need has arisen to propose a novel scheme to overcome disadvantages of the conventional display systems.

### SUMMARY OF THE INVENTION

In view of the foregoing, it is an object of the embodiment of the present invention to provide a panel self-refresh system and method that is capable of performing reset synchronization without delay, thereby speeding up updating or resynchronization.

According to one embodiment, a panel self-refresh system includes a display panel, a processor, a timing controller, a frame buffer and a gate driver. The processor sends a command or a frame. The timing controller receives the command or receives the frame as an incoming frame, the incoming frame being forwarded to the display panel in a normal state. The frame buffer stores the incoming frame in a cache state or an update state, contents of the frame buffer being read as an outgoing frame to the display panel in a self-refresh state. The gate driver disposed in the display panel outputs scan signals. The timing controller generates a reset signal to the gate driver when the processor sends an update command for entering the update state or sends an exit command for entering a resynchronization state, the scan signals of the gate driver being de-asserted and staying in a vertical blanking interval until a next incoming frame is received from the processor, therefore the timing controller synchronizes the incoming frame with the outgoing frame.

### BRIEF DESCRIPTION OF THE DRAWINGS

FIG. 1 shows a block diagram illustrated of a panel self-refresh system according to one embodiment of the present invention;

FIG. 2 shows an exemplary timing diagram of FIG. 1;

FIG. 3 shows a schematic diagram illustrated of the panel of FIG. 1;

FIG. 4A shows a circuit diagram illustrated of the gate driver of FIG. 3;

FIG. 4B and FIG. 4C show exemplary timing diagrams of the gate driver of FIG. 4A;

FIG. 5 shows a flow diagram illustrating a method of reset synchronization for the panel self-refresh system according to one embodiment of the present invention; and

FIG. 6 shows a timing diagram associated with FIG. 5.

### DETAILED DESCRIPTION OF THE INVENTION

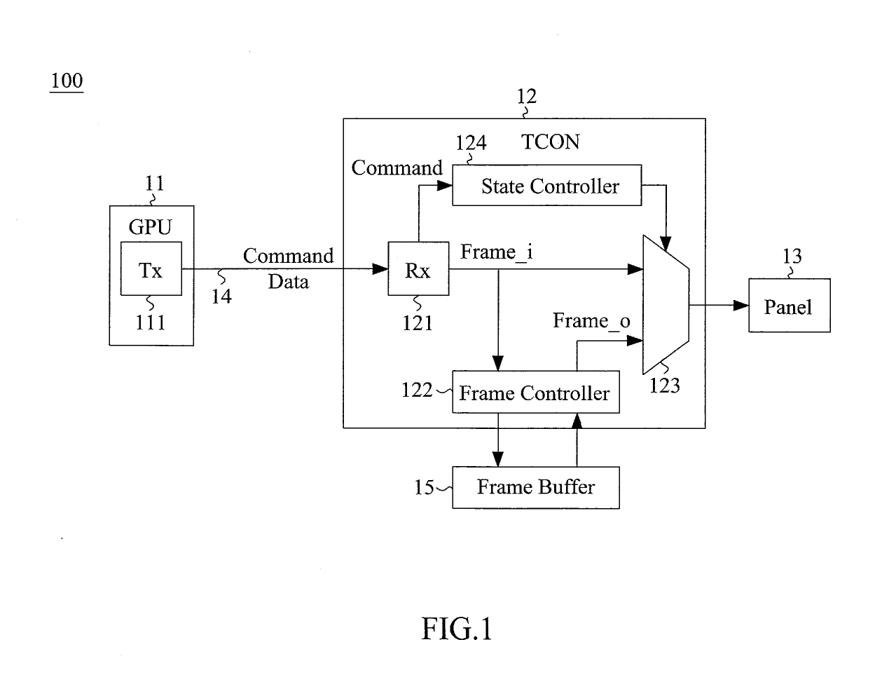

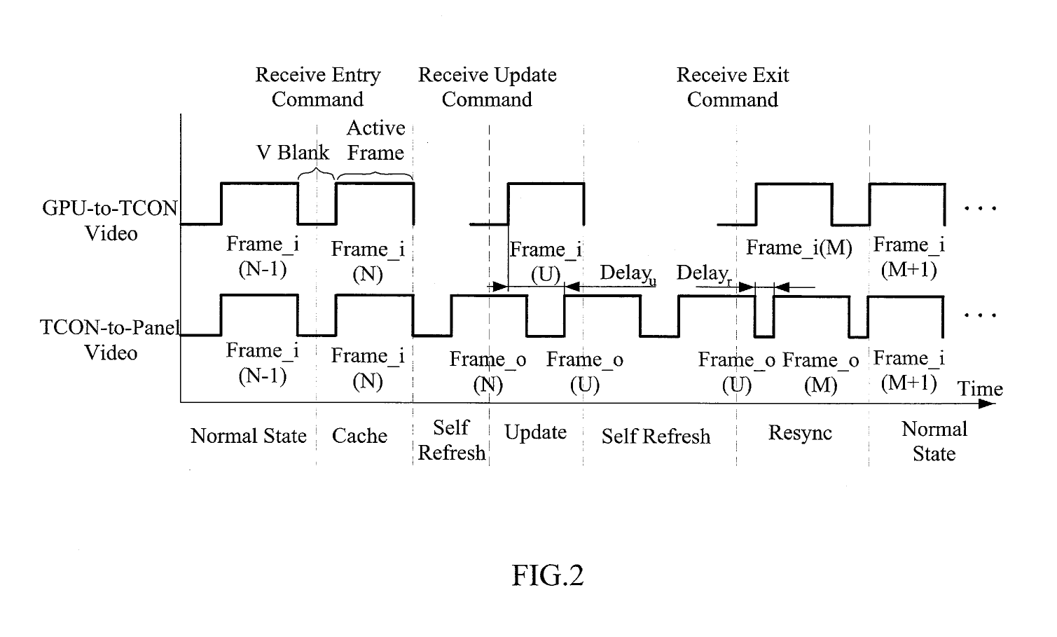

FIG. 1 shows a block diagram illustrated of a panel self-refresh system 100 according to one embodiment of the present invention. FIG. 2 shows an exemplary timing diagram of FIG. 1. In a normal state, a processor, such as a graphics processing unit (GPU), 11 generates and sends frames in sequence from a transmitter (Tx) 111 to a receiver (Rx) 121 of a timing controller (TCON hereinafter) 12, which forwards the incoming frames (Frame_i) to a display panel (panel hereinafter) 13. In this specification, the term “frame” refers to electronically coded still image in video technology.

When the GPU 11 detects no changes between the frames, the GPU 11 sends an entry command to the TCON 12 in order to enter a self-refresh state, no further frames are generated by the GPU 11 and a link 14 between the transmitter (Tx) 111 and the receiver (Rx) 121 is closed to reduce power consumption. Before actually entering the self-refresh state, the system 100 is in a cache state, during which a frame controller 122 of the TCON 12 writes the incoming frame (Frame_i) to a frame buffer 15, which is capable of storing at least one frame. In the self-refresh state, the frame controller 122 reads the frame from the frame buffer 15 and outputs the outgoing frame (Frame_o) to the panel 13.

The TCON 12 also includes a multiplexer 123, which passes the incoming frame (Frame_i) to the panel 13 in the normal state, and passes the outgoing frame (Frame_o) to the panel 13 in the self-refresh state. The multiplexer 123 is controlled by a state controller 124 under control of a command from the GPU 11.

Within the self-refresh state, the system 100 may temporarily enter an update state, during which the GPU 11 resumes the link 14 and sends an update command to the TCON 12. In the update state, the frame controller 122 of the TCON 12 writes the incoming frame (Frame_i) to the frame buffer 15. At the same time, the frame controller 122 reads the frame from the frame buffer 15 and outputs the outgoing frame (Frame_o) to the panel 13.

The self-refresh state stays until the GPU 11 detects changes between the frames, and the GPU 11 then resumes the link 14 and sends an exit command to the TCON 12 in order to return to the normal state. Before actually returning to the normal state, the system 100 is in a resynchronization state (resync state hereinafter), during which the TCON 12 synchronizes the incoming frame (Frame_i) with the outgoing frame (Frame_o).

As shown in FIG. 2, in the update state, the outgoing frame (Frame_o(U)) may probably not synchronize with the incoming frame (Frame_i(U)), therefore resulting in a delay (Delayu). In the resync state, the outgoing frame (Frame_o(M)) may probably not synchronize with the incoming frame (Frame_i(M)), therefore resulting in a delay (Delayr). In order to overcome the disadvantages discussed above, a scheme has thus been proposed below.

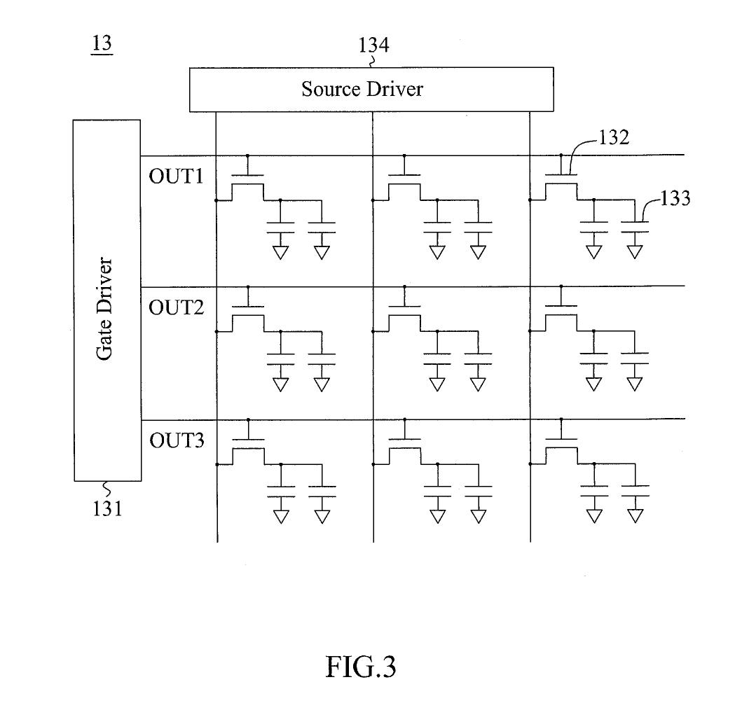

FIG. 3 shows a schematic diagram illustrated of the panel 13 of FIG. 1. The panel 13 of the embodiment includes a gate driver 131, which outputs scan signals OUT1, OUT2, OUT3, etc. to gate electrodes of thin film transistors (TFTs) 132. An asserted (e.g., high-level voltage) scan signal may open the corresponding TFTs 132, and their corresponding capacitors 133 may be charged by a source driver 134.

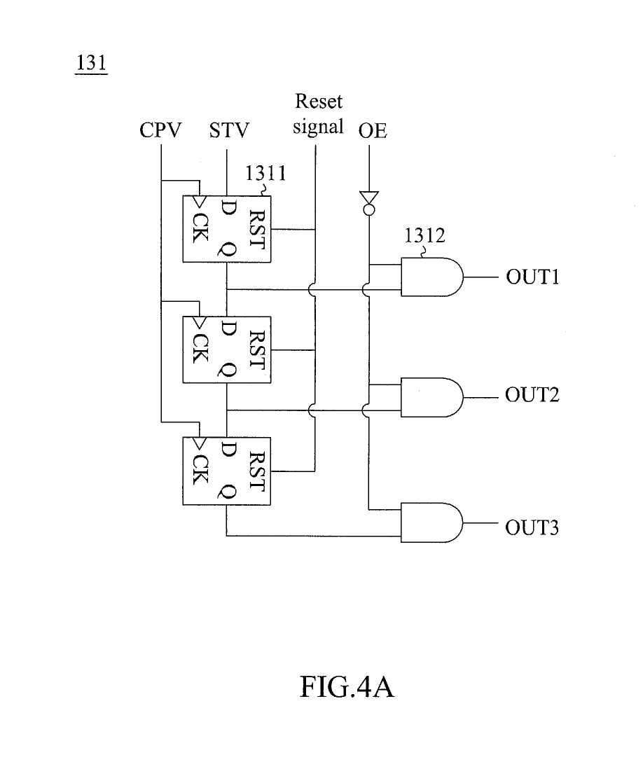

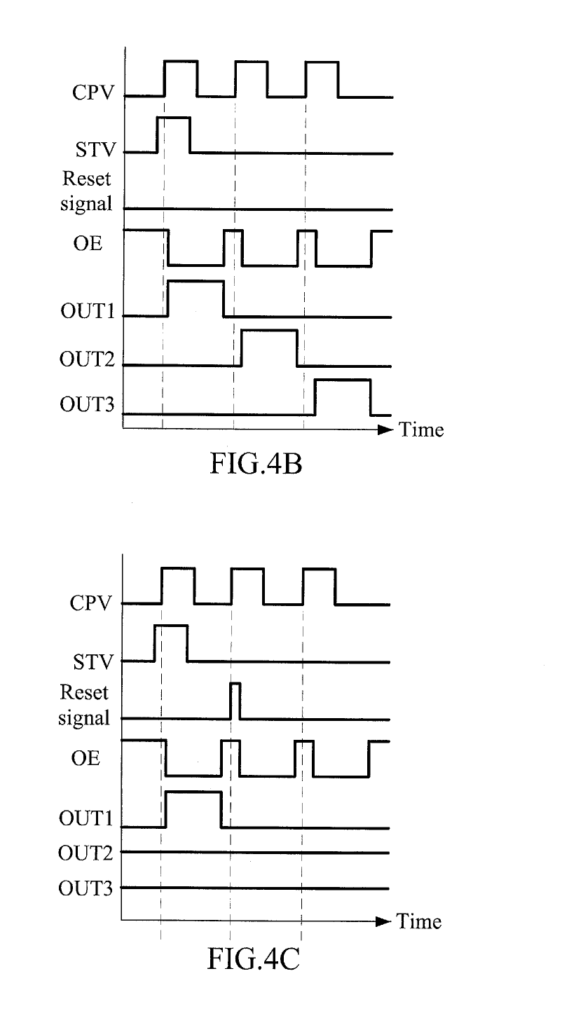

FIG. 4A shows a circuit diagram illustrated of the gate driver 131 of FIG. 3, and FIG. 4B shows an exemplary timing diagram of the gate driver 131 of FIG. 4A. In the embodiment, the gate driver 131 includes a plurality of latches (such as D-type flip-flops) 1311 connected in series, such that an output Q of a latch 1311 (except the last latch) is coupled to an input D of a succeeding latch 1311. The input D of the first latch 1311 is coupled to receive a start signal STV, representing a start of a frame. The clock input nodes CK of the latches 1311 are coupled to receive a (common) clock signal CPV. According to the configuration of the gate driver 131 shown in FIG. 4A, one output Q of the latches 1311 becomes asserted at a time. Specifically, according to the embodiment shown in FIG. 4A, the outputs Qs of the latches 1311 become asserted successively. The outputs Qs of the latches 1311 then pass logic gates (e.g., AND gates) 1312, respectively, to be the scan signals OUTx (for example, x=1, 2, 3), as shown in FIG. 4B, when an output enable signal OE is asserted (e.g., low-level voltage in this example).

According to one aspect of the embodiment, each of the latches 1311 has a reset input node RST coupled to receive a (common) reset signal. When the reset signal becomes asserted (e.g., high-level voltage), the scan signals OUTx become de-asserted (e.g., low-level voltage in this example) until the end of the current frame, as demonstrated in FIG. 4C. The signals STV, CPV, OE and the reset signal mentioned above may be provided by the TCON 12.

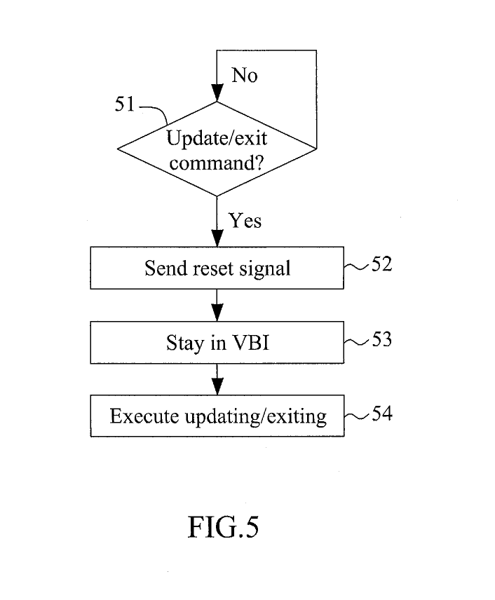

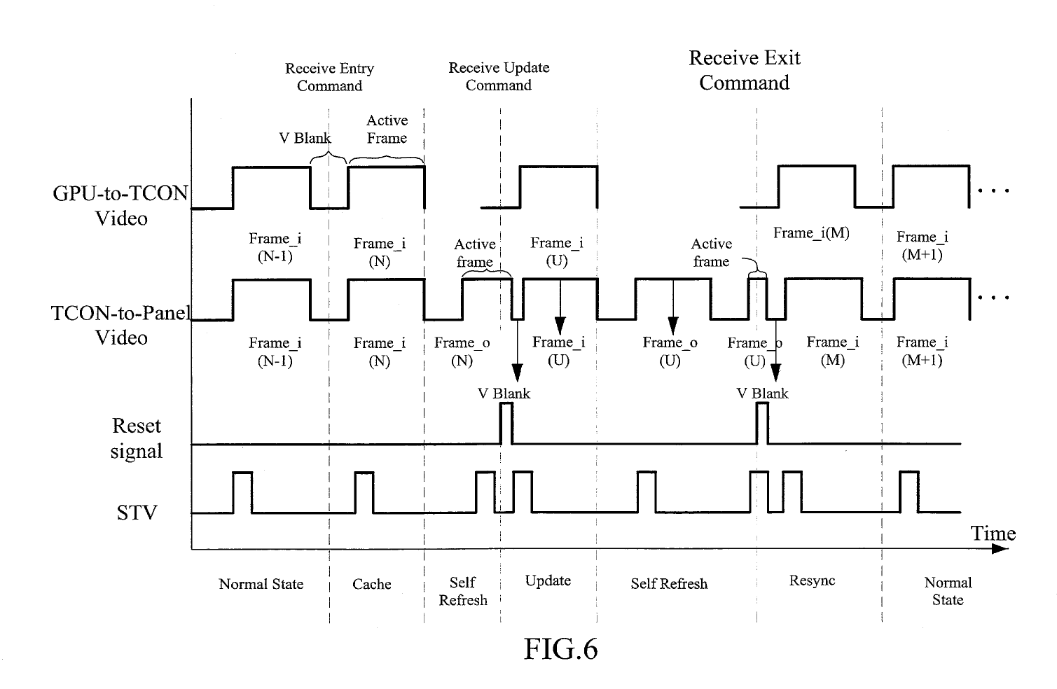

FIG. 5 shows a flow diagram illustrating a method of reset synchronization for the panel self-refresh system 100 according to one embodiment of the present invention. FIG. 6 shows a timing diagram associated with FIG. 5.

In step 51, the TCON 12 detects whether an update command or an exit command is sent from the GPU 11. If the update/ exit command is detected, the flow goes to step 52.

In step 52, the TCON 12 sends the reset signal to the gate driver 131. Upon receiving the reset signal, as described above, the scan signals OUTx become de-asserted (e.g., low-level voltage in this example) until the end of the current frame.

Next, in step 53, the TCON 12 stays in a vertical blanking interval (VBI) by discarding contents in the frame buffer 15, and stopping outputting the outgoing frame (Frame_o).

In step 54, upon receiving the incoming frame (Frame_i(U) in update state or Frame_i(M) in resync state), the system 100 exists the vertical blanking interval and executes updating (for the update state), or executes exiting or resynchronization (for the resync state). For example, in the resync state, the incoming frame (Frame_i(M)) is forwarded to the panel 13. In the update state, the incoming frame (Frame_i(U)) is written to the frame buffer while the incoming frame (Frame_i(M)) is forwarded to the panel 13.

Although specific embodiments have been illustrated and described, it will be appreciated by those skilled in the art that various modifications may be made without departing from the scope of the present invention, which is intended to be limited solely by the appended claims.

What is claimed is:

1. A panel self-refresh system, comprising:
a display panel;
a processor configured to send a command or a frame;
a timing controller configured to receive the command or receive the frame as an incoming frame, the incoming frame being forwarded to the display panel in a normal state;
a frame buffer configured to store the incoming frame in a cache state or an update state, contents of the frame buffer being read as an outgoing frame to the display panel in a self-refresh state; and
a gate driver disposed in the display panel and configured to output scan signals;
wherein the timing controller generates a reset signal to the gate driver when the processor sends an update command for entering the update state or sends an exit command for entering a resynchronization state, the scan signals of the gate driver being de-asserted and staying in a vertical blanking interval until a next incoming frame is received from the processor, therefore the timing controller synchronizes the incoming frame with the outgoing frame.

2. The system of claim 1, wherein the processor comprises a graphics processing unit.

3. The system of claim 1, wherein the processor comprises a transmitter, and the timing controller comprises a receiver, wherein the command and the frame are sent from the transmitter to the receiver.

4. The system of claim 3, wherein a link between the transmitter and the receiver is closed in the self-refresh state, and the link is resumed when entering to the update state or the resynchronization state.

5. The system of claim 1, wherein the timing controller comprises a multiplexer configured to pass the incoming frame to the display panel in the normal state, and pass the outgoing frame to the display in the self-refresh state.

6. The system of claim 5, wherein the timing controller comprises a state controller configured to control the multiplexer according to the command from the processor.

7. The system of claim 1, wherein the gate driver comprises:
a plurality of latches connected in series, each said latch having an output coupled to an input of a succeeding latch, and the input of the first latch being coupled to receive a start signal;
wherein each said latch has a reset input node coupled to receive the reset signal, and, when the reset signal becomes asserted, the scan signals become de-asserted until an end of a current outgoing frame.

8. The system of claim 7, wherein the gate driver further comprises:
a plurality of logic gates respectively coupled to receive the outputs of the latches, the outputs being passed through the logic gates, respectively, to be the scan signals when an output enable signal is asserted.

9. The system of claim 1, in the vertical blanking interval, contents in the frame buffer is discarded, and the outgoing frame is not outputted to the display panel.

10. The system of claim 1, in the update state, the incoming frame is written to the frame buffer while the incoming frame is forwarded to the display panel.

11. A panel self-refresh method, comprising the following steps not necessarily performed in sequence:
sending a command or a frame by a processor;
receiving the command or receive the frame as an incoming frame by a timing controller, the incoming frame being forwarded to a display panel in a normal state;
storing the incoming frame in a frame buffer in a cache state or an update state, contents of the frame buffer being read as an outgoing frame to the display panel in a self-refresh state;
outputting scan signals by a gate driver;
generating a reset signal to the gate driver when the processor sends an update command for entering the update state or sends an exit command for entering a resynchronization state; and
de-asserting the scan signals of the gate driver and staying in a vertical blanking interval until a next incoming frame is received from the processor, thereby synchronizing the incoming frame with the outgoing frame.

12. The method of claim 11, wherein a link between the processor and timing controller is closed in the self-refresh state, and the link is resumed when entering to the update state or the resynchronization state.

13. The method of claim 11, wherein the incoming frame and the outgoing frame are multiplexed such that the incoming frame is passed to the display panel in the normal state, and the outgoing frame is passed to the display in the self-refresh state.

14. The method of claim 13, wherein the multiplexing of the incoming frame and the outgoing frame is carried out according to the command from the processor.

15. The method of claim 11, further comprising, in the vertical blanking interval, discarding contents in the frame buffer, and stopping outputting the outgoing frame to the display panel.

16. The method of claim 11, further comprising, in the update state, writing the incoming frame to the frame buffer while the incoming frame is forwarded to the display panel.
